(19) United States
(12) Patent Application Publication
(10) Pub. No.: US 2026/0008280 A1
(43) Pub. Date: Jan. 8, 2026

(54) POWER TRANSMISSION DEVICE, MEDIUM TRANSPORT DEVICE, AND RECORDING DEVICE

(71) Applicant: SEIKO EPSON CORPORATION, Tokyo (JP)

(72) Inventor: Takeru OGUCHI, CHINO-SHI (JP)

(21) Appl. No.: 19/259,299

(22) Filed: Jul. 3, 2025

(30) Foreign Application Priority Data
Jul. 5, 2024 (JP) 2024-108725

(51) Int. Cl. B41J 13/00; B41J 13/03

(52) U.S. Cl. CPC B41J 13/0009; B41J 13/03

(57) ABSTRACT

A power transmission device includes a first gear provided on a first rotation shaft, a second gear that is provided on a second rotation shaft and that meshes with the first gear, a first support section that supports the first rotation shaft, and a second support section that supports the second rotation shaft, wherein the second support section allows movement of the second rotation shaft in an advance and retract direction in which the second gear advances and retracts with respect to the first gear and a force in a direction toward the first gear acts on the second gear.

The present application is based on, and claims priority from, JP Application Serial Number 2024-108725, filed Jul. 5, 2024, the disclosure of which is hereby incorporated by reference herein in its entirety.

### BACKGROUND

### 1. Technical Field

The present disclosure relates to a power transmission device that transmits power, and a medium transport device including the power transmission device. The present disclosure also relates to a recording device including the medium transport device.

### 2. Related Art

In a device that transmits power by two gears that mesh with each other, such as the drive device described in JP-A-2014-142038, the interaxial distance between the two meshing gears is important. Note that in this specification, the interaxial distance means the distance between the rotational axial centers of two gears. If the interaxial distance is shorter than an appropriate value, there is a possibility that the gears may be damaged or the driving load may increase, and if the interaxial distance is longer than an appropriate value, there is a possibility that, due to a decrease in the meshing ratio, power transmission may be insufficient or durability may decrease.

In order to overcome such a problem, a configuration may be adopted in which one gear is pressed against the other gear by using a planetary gear mechanism. According to such a configuration, it is possible to suppress the interaxial distance from becoming greater than an appropriate value, and even when the interaxial distance becomes shorter, one gear is pressed against the other gear by the pressing force, so that damage to the gears and an increase in the drive load are unlikely to occur.

A planetary gear mechanism tends to require a large space for installation, and may cause an increase in the size of the device.

### SUMMARY

A power transmission device of the present disclosure for overcoming the above problem includes a first gear provided on a first rotation shaft; a second gear that is provided on a second rotation shaft and that meshes with the first gear; a first support section that supports the first rotation shaft; and a second support section that supports the second rotation shaft, wherein the second support section allows movement of the second rotation shaft in an advance and retract direction in which the second gear advances and retracts with respect to the first gear and a force in a direction toward the first gear acts on the second gear.

A medium transport device according to the present disclosure includes the power transmission device and a feed roller that feeds a medium by rotating by receiving power from the second gear via the first gear.

A recording device according to the present disclosure includes the medium transport device and a recording section that performs recording on the medium transported by the medium transport device.

### BRIEF DESCRIPTION OF THE DRAWINGS

FIG. 1 is a diagram illustrating the overall transport path of a medium in a printer.

FIG. 2 is a perspective view of a motor fixing frame attached to an attachment frame.

FIG. 3 is a cross-sectional view of the attachment frame and the motor fixing frame.

FIG. 4 is a perspective view of a power transmission device.

FIG. 5 is a plan view of a part of the power transmission device.

FIG. 6 is a plan view of the power transmission device schematically shown.

FIG. 7 is a diagram illustrating a meshing section of a first gear and a second gear.

FIG. 8 is a diagram showing an embodiment of the arrangement of the second gear with respect to the first gear.

FIG. 9 is a diagram showing an embodiment of the arrangement of the second gear with respect to the first gear.

FIG. 10 is a diagram showing an embodiment of the arrangement of the second gear with respect to the first gear.

FIG. 11 is a diagram showing an embodiment of the arrangement of a fourth gear with respect to a third gear.

### DESCRIPTION OF EMBODIMENTS

Hereinafter, the present disclosure will be generally described.

A power transmission device according to a first aspect includes a first gear provided on a first rotation shaft; a second gear that is provided on a second rotation shaft and that meshes with the first gear; a first support section that supports the first rotation shaft; and a second support section that supports the second rotation shaft, wherein the second support section allows movement of the second rotation shaft in an advance and retract direction in which the second gear advances and retracts with respect to the first gear and a force in a direction toward the first gear acts on the second gear.

According to the present aspect, since it has a configuration in which the second support section allows movement of the second rotation shaft in the advance and retract direction in which the second gear advances and retracts with respect to the first gear and the force in the direction toward the first gear acts on the second gear, it is possible to realize a configuration for advancing and retracting the second gear with respect to the first gear in a space-saving manner and to suppress an increase in size of the device. That is, compared to a case where a planetary gear mechanism is used, a configuration for the second gear to advance and retract with respect to the first gear can be realized in a space-saving manner, and an increase in the size of the device can be suppressed. Further, appropriate meshing between the first gear and the second gear can be realized, and appropriate power transmission can be realized.

A second aspect is an aspect according to the first aspect, further including a pressing member that presses the second rotation shaft toward the first rotation shaft, wherein the force in the direction toward the first gear acts on the second gear by the second rotation shaft being pressed by the pressing member.

According to the present aspect, the pressing member presses the second rotation shaft toward the first rotation shaft, and thus meshing between the first gear and the second gear can be appropriately maintained.

A third aspect is an aspect according to the first aspect, wherein the force in the direction toward the first gear acts on the second gear due to weight of the second rotation shaft and weight of the second gear.

According to the present aspect, since the force in the direction toward the first gear acts on the second gear due to the weight of the second rotation shaft and the weight of the second gear, a dedicated component for applying the force in the direction toward the first gear to the second gear, for example, a spring or the like, is not required, or even in a case where a spring is used, the spring force may be small, and thus it is possible to reduce the size and cost of the device.

A fourth aspect is an aspect according to the first aspect, wherein when viewed from an axial direction of the first rotation shaft, a first straight line that passes through a first axial center of the first rotation shaft and through a second axial center of the second rotation shaft is non-parallel to an advancing direction in which the second gear advances toward the first gear and assuming that a straight line that passes through the first axial center and that is parallel to the advancing direction is a second straight line, the second axial center is located further than the second straight line in a direction of a reactive force received by the second gear from the first gear.

According to the present aspect, since the second axial center is located further than the second straight line in the direction of the reactive force received by the second gear from the first gear, even when a component force of the reactive force received by the second gear from the first gear acts in the advancing direction in which the second gear advances toward the first gear or acts in the direction opposite to the advancing direction, the magnitude of the component force is reduced. This makes it possible to appropriately maintain meshing between the first gear and the second gear.

Note that the present aspect is not limited to the first aspect above, and may be an aspect according to the second or third aspect above.

A fifth aspect is an aspect according to the fourth aspect, wherein when viewed from the axial direction of the first rotation shaft, the first straight line that passes through the first axial center of the first rotation shaft and through the second axial center of the second rotation shaft is non-parallel with the advance and retract direction of the second gear and a component force of the reactive force received by the second gear from the first gear acts in the advancing direction.

According to the present aspect, since the component force of the reactive force received by the second gear from the first gear at the pitch point where a tooth of the first gear contacts a tooth of the second gear acts in the advancing direction, appropriate meshing between the first gear and the second gear can be maintained compared to the case where the component force in the direction in which the second gear retracts from the first gear.

Note that reactive force received by the second gear from the first gear means a reactive force received by the second gear at the pitch point where a tooth of the first gear and tooth of the second gear contact each other and is the reactive force that acts along the normal line direction of a tooth surface of the second gear at the pitch point.

A sixth aspect is an aspect according to the fourth aspect, wherein when viewed from the axial direction of the first rotation shaft, an angle formed by the first straight line that passes through the first axial center of the first rotation shaft and through the second axial center of the second rotation shaft and the advance and retract direction of the second gear is larger than a pressure angle of the second gear and also smaller than 90° and an angle formed by a direction in which the reactive force received by the second gear from the first gear acts and the advancing direction is an acute angle.

According to the present aspect, since the angle formed by the advancing direction and the direction in which the reactive force received by the second gear from the first gear at the pitch point where a tooth of the first gear contacts a tooth of the second gear is an acute angle, the component force of the reactive force received by the second gear from the first gear acts in the advancing direction. This makes it possible to appropriately maintain meshing between the first gear and the second gear.

Note that reactive force received by the second gear from the first gear means a reactive force received by the second gear at the pitch point where a tooth of the first gear and tooth of the second gear contact each other and is the reactive force that acts along the normal line direction of a tooth surface of the second gear at the pitch point.

A seventh aspect is an aspect according to the fourth aspect, wherein when viewed from an axial direction of the first rotation shaft, an angle formed by the first straight line and the advance and retract direction of the second gear is equal to a pressure angle of the second gear.

According to the present aspect, since the angle formed by the first straight line and the advance and retract direction of the second gear is equal to the pressure angle of the second gear, the direction in which the reactive force received by the second gear from the first gear acts is orthogonal to the advance and retract direction of the second gear. By this, it is possible to suppress the reactive force from adversely affecting the force in the direction in which the second gear moves toward the first gear.

An eighth aspect is an aspect according to the first aspect, wherein the first gear includes a first flanged section coaxial with the first gear, the second gear includes a second flanged section coaxial with the second gear, a sum of a diameter of the first flanged section and a diameter of the second flanged section is smaller than a sum of a diameter of a tip circle of the first gear and a diameter of a tip circle of the second gear and also is larger than a sum of a diameter of a root circle of the first gear and a diameter of a root circle of the second gear and the second flanged section abuts against the first flanged section by the force acting on the second gear in a direction toward the first gear.

According to the present aspect, the second flanged section abuts against the first flanged section by the force that is in the direction toward the first gear and that acts on the second gear, and thus the interaxial distance between the first rotation shaft and the second rotation shaft is appropriately maintained, and the first gear and the second gear can appropriately mesh with each other. In particular, even when the force acting on the second gear in the direction toward the first gear is large, the first gear and the second gear can be appropriately meshed with each other.

Note that the present aspect is not limited to the first aspect and may be dependent on any of the second to seventh aspects.

A ninth aspect is an aspect according to the eighth aspect, further including a clutch configured to switch between connection and disconnection of power transmission between the first gear and the first rotation shaft, wherein a housing of the clutch also serves as the first flanged section.

According to the present aspect, since the housing of the clutch also serves as the first flanged section, it is not necessary to provide the first flanged section as a dedicated member, and it is possible to reduce the size and cost of the device.

A tenth aspect is an aspect according to the first aspect, wherein the second support section is configured by an alignment bearing.

According to present aspect, since the second support section is configured by an alignment bearing, it is possible to easily obtain a configuration that allows movement of the second rotation shaft in the advance and retract direction in which the second gear advances and retracts with respect to the first gear.

Note that the present aspect is not limited to the first aspect and may be according to any one of the second to ninth aspects.

An eleventh aspect is an aspect according to the first aspect, wherein the second support section includes a bearing section that receives the second rotation shaft and that is supported by a frame and the bearing section has play between itself and the frame that allows movement of the second rotation shaft in the advance and retract direction.

According to the present aspect, since movement of the second rotation shaft in the advance and retract direction is allowed by providing play between the bearing section and the frame, the second support section can be configured at low cost.

Note that the present aspect is not limited to the first aspect and may be according to any one of the second to ninth aspects.

A twelfth aspect according to any one of the first to eleventh aspects, further including a third gear provided on a third rotation shaft and a fourth gear that is provided on the second rotation shaft spaced apart from the second gear in an axial direction and that meshes with the third gear, wherein when viewed from an axial direction of the third rotation shaft, the advance and retract direction of the second gear is along a direction orthogonal to a straight line passing through an axial center of the second rotation shaft and an axial center of the third rotation shaft.

When the second rotation shaft moves so that the second gear advances and retracts with respect to the first gear, the fourth gear provided on the second rotation shaft is also displaced, and thus there is a concern that the third gear and the fourth gear may not appropriately mesh with each other.

However, according to the present aspect, when viewed from the axial direction of the third rotation shaft, the advance and retract direction of the second gear is along a direction orthogonal to a straight line passing through the axial center of the second rotation shaft and the axial center of the third rotation shaft. By this, even when the second rotation shaft moves, it is possible to suppress a change in the interaxial distance between the third rotation shaft and the second rotation shaft, and it is possible to suppress that meshing between the third gear and the fourth gear from becoming inappropriate.

A thirteenth aspect according to any one of the first to eleventh aspects, further including a third gear provided on a third rotation shaft and a fourth gear that is provided on the second rotation shaft spaced apart from the second gear in an axial direction and that meshes with the third gear, wherein the second support section is located between the second gear and the fourth gear in the axial direction of the second rotation shaft and a distance between the fourth gear and the second support section is shorter than a distance between the second gear and the second support section.

According to the present aspect, since the second support section is located between the second gear and the fourth gear in the axial direction of the second rotation shaft, and the distance between the fourth gear and the second support section is shorter than the distance between the second gear and the second support section, when the second rotation shaft moves with the second support section as a fulcrum, the displacement amount of the fourth gear can be suppressed more than the displacement amount of the second gear. This can suppress that the third gear and the fourth gear mesh improperly.

Note that the present aspect may be according to the twelfth aspect.

A medium transport device according to a fourteenth aspect includes the power transmission device according to the first aspect and a feed roller that feeds a medium by rotating by receiving power from the second gear via the first gear.

According to the present aspect, the operation and effect of the first aspect described above are obtained in the medium transport device.

Note that the present aspect is not limited to the power transmission device according to the first aspect, and may include the power transmission device according to any one of the second to thirteenth aspects.

A fifteenth aspect is an aspect according to the fourteenth aspect, further including a medium support section that supports the medium before feeding, wherein the feed roller feeds the medium from the medium support section.

According to present aspect, in the configuration in which the feed roller feeds the medium from the medium support section, the operational effect of the fourteenth aspect described above is obtained.

A recording device according to a sixteenth aspect includes the medium transport device according to the fourteenth or fifteenth aspect and a recording section that performs recording on the medium transported by the medium transport device.

According to present aspect, the recording device obtains the operational effect of the fourteenth or fifteenth aspect described above.

Hereinafter, the present disclosure will be described in detail.

Hereinafter, an inkjet printer 1 that performs recording by ejecting ink, which is an example of liquid, onto a medium represented by a recording sheet, will be described as an example of a recording device. Hereinafter, the inkjet printer 1 will be referred to simply as a printer 1.

Note that the recording device is not limited to an ink jet printer. Examples of the recording device include various printers such as a laser printer, a dot impact printer, and a thermal printer.

An X-Y-Z coordinate system illustrated in each drawing is an orthogonal coordinate system, and a Y-axis direction is the medium width direction, which intersects the transport direction of a medium, and is the apparatus depth direction. In the present embodiment, among the side surfaces constituting the periphery of the housing 2, the side surface in the +Y direction is the back surface, and the side surface in the −Y direction is the front surface.

An X-axis direction is the device width direction and, as viewed from an operator of the printer 1, a +X direction is to the left side and a −X direction is to the right side. The −X direction is a medium feed direction from each medium cassette (to be described later).

A Z-axis direction is a vertical direction, that is, a device height direction, a +Z direction is an upward direction, and a −Z direction is a downward direction.

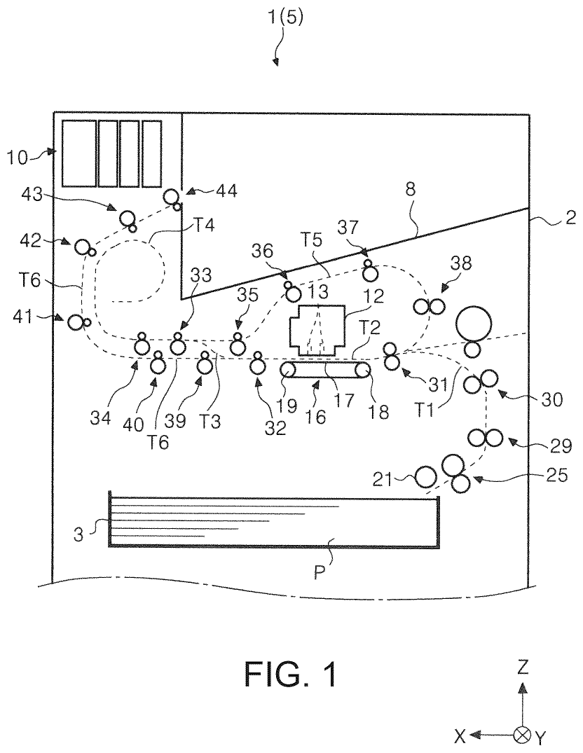

Hereinafter, a direction in which the medium is transported may be referred to as “downstream”, and an opposite direction of it may be referred to as “upstream”. In FIG. 1, the transport path of the medium is indicated by dashed line. In the printer 1, the medium is transported through a transport path indicated by broken line. In FIG. 1, reference symbols T1, T2, T3, T4, T5, and T6 denote transport paths. Each of the transport paths will be described later.

Note that the printer 1 may be referred to as a medium transport device 5 from the viewpoint of transporting a medium. In this case, the printer 1 is an example of a recording device including the medium transport device 5 and a line head 12 (to be described later).

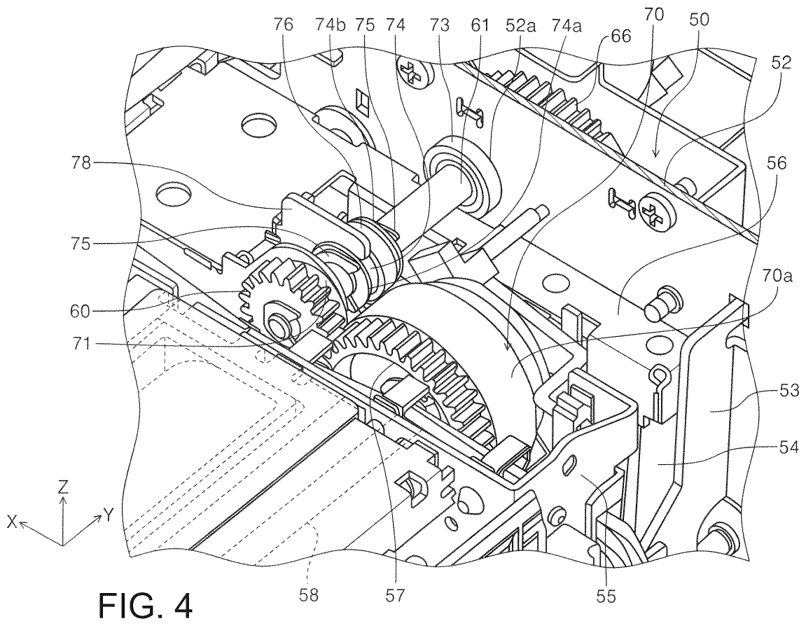

In particular, the medium transport device 5 is a device including a medium cassette 3 (to be described later), a pickup roller 21 that feeds a medium from the medium cassette 3, and a power transmission device 50 (see FIG. 4) that transmits power of a motor (not shown) to the pickup roller 21.

The printer 1 includes a medium cassette 3 in a lower section of the housing 2, which includes the line head 12 (to be described later). The reference symbol P indicates medium accommodated in the medium cassette 3. The medium cassette 3 is an example of a medium support section that supports a medium before feeding.

The pickup roller 21 that feeds the accommodated medium in the −X direction is provided with respect to the medium cassette 3. The pickup roller 21 is an example of a feed roller that feeds a medium from the medium cassette 3 by rotating.

A feed roller pair 25 that feeds the medium sent out by the pickup roller 21 further downstream is provided with respect to the medium cassette 3. Note that a plurality of medium cassettes (not shown) are further provided below the medium cassette 3. A pickup roller (not shown) and a feed roller pair (not shown) are provided for each of the plurality of medium cassettes (not shown).

Note that in the following, unless otherwise specifically described, the term “roller pair” is assumed to be configured by a drive roller driven by a power source such as a motor and a driven roller that is in contact with the drive roller and that rotates in a driven manner.

The reference symbol T1 indicates a transport path of medium that is fed from the medium cassette 3 and that reaches the transport roller pair 31, in other words, a feed path. The medium fed from the medium cassette 3 receives a feeding force from the transport roller pairs 29 and 30 and is fed to the transport roller pair 31. In the present embodiment, the feed path T1 is a path from the medium cassette 3 to the transport roller pair 31.

The medium that receives the feeding force from the transport roller pair 31 is fed to the transport path T2. The line head 12, which is an example of a recording section, and a transport belt 17 are provided in the transport path T2. A position facing the line head 12 in the transport path T2 is a recording position. In the present embodiment, the transport path T2 is a linear path from the transport roller pair 31 to the transport roller pair 32.

The line head 12 includes nozzles 13, and performs recording by ejecting ink from the nozzles 13 onto a medium. In the present embodiment, the direction in which ink is ejected from the nozzles 13 is the −Z direction. The line head 12 is an ink ejection head in which a plurality of nozzles 13 for ejecting ink are arranged so as to cover the entire region in the medium width direction, and is configured as an ink ejection head capable of recording on the entire region in the medium width direction without moving in the medium width direction. However, the ink ejection head is not limited to this, and may be of a type that is mounted on a carriage and that ejects ink while moving in the medium width direction.

The line head 12 according to the present embodiment ejects, for example, a plurality of colors of ink. Specifically, in the present embodiment, the plurality of nozzles 13 include a plurality of nozzles 13 that eject yellow ink, a plurality of nozzles 13 that eject magenta ink, a plurality of nozzles 13 that eject cyan ink, and a plurality of nozzles 13 that eject black ink.

The transport belt 17 is an endless belt wound around a first roller 18, which is a driving roller, and a second roller 19, which is a driven roller and which rotates as the first roller 18 is driven by a motor (not shown). A medium is transported to a position facing the line head 12 while being attracted to a belt surface of the transport belt 17.

The first roller 18, the second roller 19, and the transport belt 17 constitute a belt unit 16.

The medium on which recording is performed by the line head 12 is sent toward either of the transport roller pair 33 and the transport roller pair 39 by the transport roller pair 32, which is located downstream of the belt unit 16. A switching unit (not shown) for switching the transport path is provided downstream of the transport roller pair 32.

Assuming that the medium has a first surface and a second surface opposite to the first surface, and that recording is performed on the first surface first, the medium is sent to the discharge path T6 in a case where the medium is discharged without performing recording on the second surface, or in a case where the medium is discharged after performing recording on the second surface. In the present embodiment, the discharge path T6 is a path from the transport roller pair 32 to the transport roller pair 44 via the transport roller pairs 39, 40, 41, 42, and 43. The discharge path T6 has a shape that curves and inverts the medium with the surface on which recording was most recently performed facing inward.

The medium sent to the discharge path T6 is discharged face-down toward the discharge tray 8 by the transport roller pair 44. Note that the transport path may further branch off at the discharge path T6. For example, in addition to the path for discharging the medium face-down as illustrated in the drawing, a path for discharging the medium face-up to a discharge tray that is not shown or to another device may be provided.

When recording is performed on the second side of the medium, that is, when double-sided recording is to be performed, the medium is sent to the guide path T3. In the present embodiment, the guide path T3 is a path from the transport roller pair 32 to the transport roller pair 33.

The medium is further sent to the switchback path T4 by the transport roller pair 33. In the present embodiment, the switchback path T4 is a path in the +X direction from the transport roller pair 33. The switchback path T4 has a shape that curves and inverts the medium with the surface on which the recording is performed most recently facing inward. The switchback path T4 is a path for switching back the medium to reverse the front and back of the medium on which recording was performed by the line head 12. In addition to the transport roller pair 33, a transport roller pair 34 is further provided in the switchback path T4.

When the medium enters the switchback path T4, the rotation direction of the transport roller pairs 33 and 34 is switched, the medium is sent in the −X direction, and enters the inversion path T5.

In the present embodiment, the inversion path T5 is a path from the transport roller pair 33 to the transport roller pair 31 via the transport roller pairs 35, 36, 37, and 38. The inversion path T5 passes above the line head 12 and has a shape that curves and inverts the medium with the surface on which the recording was most recently performed facing outward. The inversion path T5 is a path that inverts the medium that was switched back in the switchback path T4 and that re-transports the medium to the feed path T1.

The medium transported in the inversion path T5 enters the feed path T1 upstream of the transport roller pair 31, and recording is performed by the line head 12.

Note that reference symbol 10 denotes an ink accommodation section as a liquid storage section that stores ink before ejection. The ink ejected from the line head 12 is supplied from the ink accommodation section 10 to the line head 12 via a tube (not shown). The ink accommodation section 10 contains, for example, black, yellow, magenta, and cyan inks.

The overall configuration of the printer 1 has been described above, and an example of a mechanism for transmitting power from a motor to a roller will be described below.

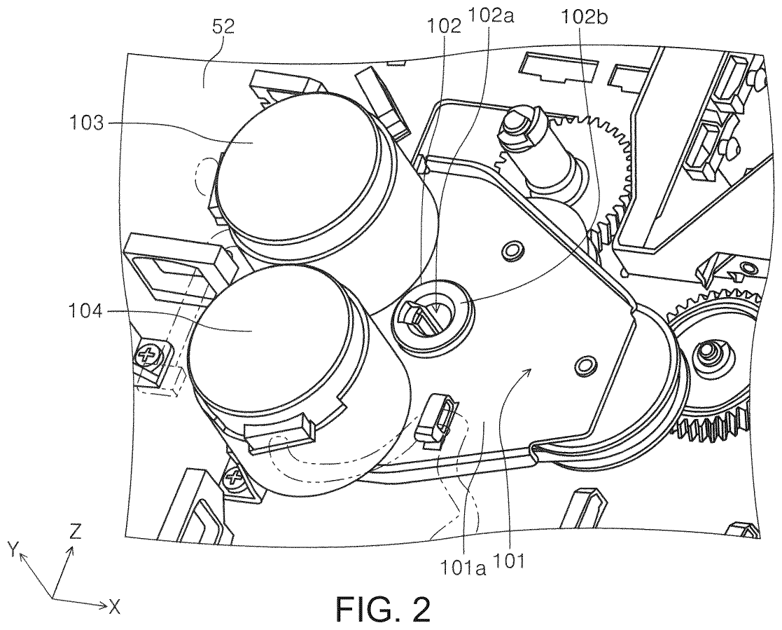

A part of the base of the housing 2 is constituted by a first frame 52 (see FIGS. 2 to 4). The first frame 52 is provided with a motor for driving each roller, and a power transmission mechanism such as a gear and a pulley for transmitting power from the motor to each roller.

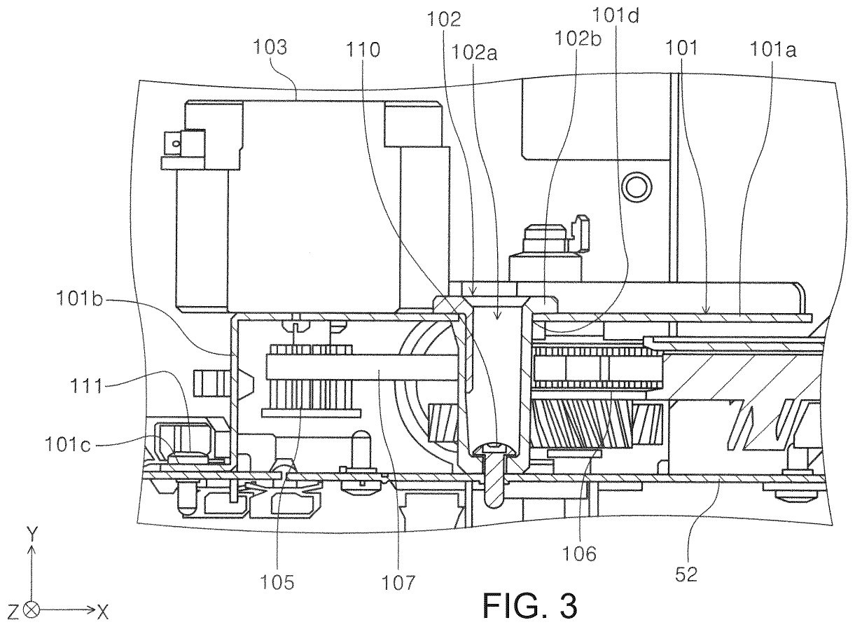

As an example, FIGS. 2 and 3 illustrate a first motor 103 that drives the transport roller pair 44, a second motor 104 that drives the transport roller pair 43, and a part of a mechanism that transmits power from the motors to the respective roller pairs.

The first motor 103 and the second motor 104 are attached to a motor fixing frame 101. The motor fixing frame 101 includes a first plate section 101a that is a section to which the first motor 103 and the second motor 104 are fixed and that forms a surface parallel to the first frame 52, a second plate section 101b that is a section orthogonal to the first plate section 101a, and a third plate section 101c that forms a surface parallel to the first frame 52. The first plate section 101a is connected to one end of the second plate section 101b, and the third plate section 101c is connected to the other end of the second plate section 101b.

FIG. 3 illustrates a drive pulley 105 provided on a drive shaft of the first motor 103, a driven pulley 106, and an endless belt 107 wound around the drive pulley 105 and the driven pulley 106. Although detailed illustration and description are omitted, the driven pulley 106 transmits power to the transport roller pair 44.

The third plate section 101c is fixed to the first frame 52 by a fixing screw 111. Note that although one fixing screw 111 is shown in FIG. 3, the third plate section 101c is fixed to the first frame 52 by two fixing screws 111 that are spaced apart by a gap in the Z-axis direction.

A hole 101d is formed in the first plate section 101a, and a cylindrical member 102 is inserted through the hole 101d. The cylindrical member 102 has a flanged section 102b and a hollow section 102a. A fixing screw 110 can be inserted into the hollow section 102a, and the cylindrical member 102 can be fixed to the first frame 52 by the fixing screw 110. The first plate section 101a is positioned with respect to the first frame 52 via the flanged section 102b of the cylindrical member 102.

In this way, by using the structure in which the motor fixing frame 101 is fixed to the first frame 52 via the cylindrical member 102, even when space for providing a screw fixing section, such as the third plate section 101c, cannot be secured, the motor fixing frame 101 can be fixed. In addition, since the fixing screw 110 is inserted into the hollow section 102a of the cylindrical member 102, it is possible to suppress the fixing screw 110 from falling between the first plate section 101a and the first frame 52, and thus, the workability at the time of attaching or detaching the motor fixing frame 101 is improved.

Next, the power transmission device 50 will be described in detail with reference to FIG. 4 and subsequent drawings.

The power transmission device 50 is a device that transmits power of a motor (not shown) from a second gear 60 to a first gear 57 and further to a first rotation shaft 58. Power transmitted to the first rotation shaft 58 is transmitted to the pickup roller 21 (see FIG. 1).

Note that the feed roller to which the power is transmitted by the power transmission device 50 is not limited to the pickup roller 21, and may be another transport roller pair.

More specifically, in FIG. 4, the power transmission device 50 has a first frame 52 that forms a surface parallel to the X-Z plane. A bearing hole 52a is formed in the first frame 52, and a bearing section 73 is held in the bearing hole 52a. The bearing section 73 is an example of a second support section and supports a second rotation shaft 61. In the present embodiment, the bearing section 73 is a rolling bearing, but may be a slide bearing. The inner diameter of the bearing hole 52a is sufficiently larger than the outer diameter of the bearing section 73, that is, play is provided between the inner peripheral surface of the bearing hole 52a and the outer peripheral surface of the bearing section 73. By this, the second rotation shaft 61 supported by the bearing section 73 can move so that its axial center line tilts with the bearing section 73 as a fulcrum. With such a configuration, a configuration in which the second rotation shaft 61 can move with the bearing section 73 as a fulcrum can be obtained at low cost.

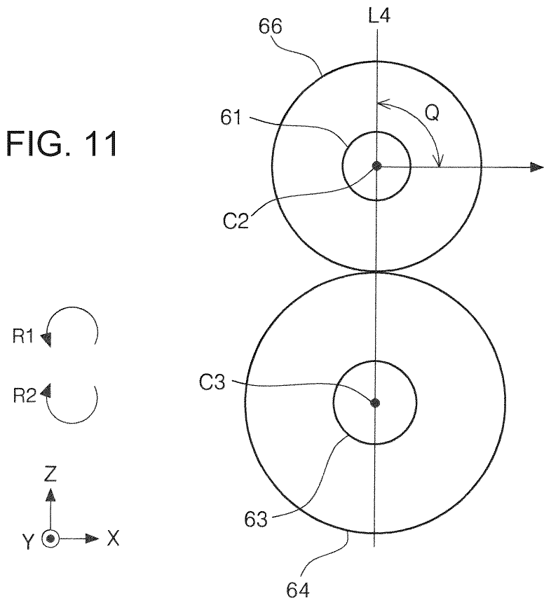

The second rotation shaft 61 is disposed so as to penetrate through the first frame 52 along the Y-axis direction, and a fourth gear 66 is provided on the second rotation shaft 61 in the +Y direction with respect to the first frame 52. As shown in FIG. 11, a third gear 64 is provided below the fourth gear 66, and the fourth gear 66 and the third gear 64 mesh with each other. The third gear 64 is provided on a third rotation shaft 63, and the third rotation shaft 63 rotates by obtaining power from a motor (not shown). Therefore, power from the motor (not shown) is transmitted from the third gear 64 to the fourth gear 66, and by this, the second rotation shaft 61 rotates.

Returning to FIG. 4, the second gear 60 is provided at the −Y direction end section of the second rotation shaft 61. The second gear 60 is integrally provided with a second flanged section 71. The second gear 60 meshes with the first gear 57 and transmits power to the first gear 57.

In the present embodiment, the first gear 57 is provided integrally with a housing 70a of an electromagnetic clutch 70.

Under the control of a control section (not shown), the electromagnetic clutch 70 switches between a state in which power is transmitted to the first rotation shaft 58 and a state in which power is not transmitted to the first rotation shaft 58.

A frame assembly constituted by a second frame 53, a third frame 54, a fourth frame 55, and a fifth frame 56 is provided in the −Y direction with respect to the first frame 52, and the electromagnetic clutch 70 is supported by the fourth frame 55. The second frame 53 is attached to the first frame 52. The third frame 54 is attached to the second frame 53. The fourth frame 55 is attached to the third frame 54. Since the electromagnetic clutch 70 is supported by the fourth frame 55, dimensional tolerances of the first frame 52, the second frame 53, the third frame 54, and the fourth frame 55 are interposed between the first gear 57 and the second gear 60.

At least a section of the first rotation shaft 58 in its axial direction is supported by the electromagnetic clutch 70. Therefore, the electromagnetic clutch 70 is an example of a first support section that fixedly supports the first rotation shaft 58.

As described above, the second rotation shaft 61 can move so that its axial center line tilts with the bearing section 73 as a fulcrum. In the present embodiment, the second rotation shaft 61 can move so that the second gear 60 advances and retracts with respect to the first gear 57.

A flanged bearing 74 is provided on the second rotation shaft 61 between the bearing section 73 and the second gear 60. The flanged bearing 74 is held by two e-rings 75 so as not to move in the axial direction of the second rotation shaft 61.

The flanged bearing 74 has flanged sections 74a and 74b. A large diameter section 76 is provided between the flanged sections 74a and 74b and, by this, two small diameter sections are provided between the flanged sections 74a and 74b along the axial direction.

A guide plate 78 is inserted into a small diameter section between the large diameter section 76 and the flanged section 74a. The guide plate 78 is open in the −X direction, and the inside of the opening extends along the X-axis direction, whereby the second rotation shaft 61 is guided in the X-axis direction. By this, the second rotation shaft 61 can swing in the X-Y plane with the bearing section 73 as a fulcrum.

One end 77a of a torsion coil spring 77, which is an example of a pressing member, is inserted into a small diameter section between the large diameter section 76 and the flanged section 74b. The one end 77a presses the flanged bearing 74 in the −X direction, that is, presses the second rotation shaft 61 in the −X direction. The torsion coil spring 77 presses the second rotation shaft 61 via the flanged bearing 74, thereby avoiding the occurrence of frictional resistance due to sliding between the rotating second rotation shaft 61 and the torsion coil spring 77.

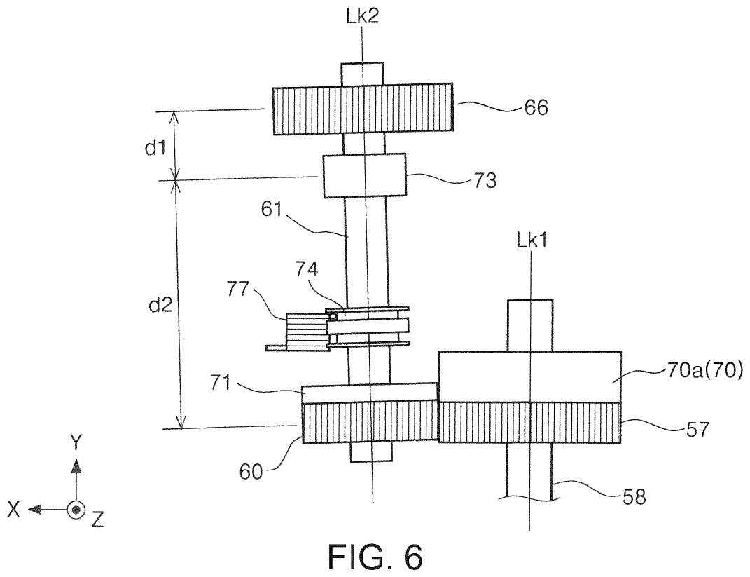

In FIG. 6, a straight line indicated by reference symbol Lk1 is an axial center line of the first rotation shaft 58, and a straight line indicated by reference symbol Lk2 is an axial center line of the second rotation shaft 61. In the present embodiment, the axial center line Lk1 is parallel to the Y-axis direction. In the present embodiment, in a state in which the second gear 60 is meshed with the first gear 57, the axial center line Lk2 is inclined with respect to the Y-axis direction. That is, in the present embodiment, the axial center line Lk1 and the axial center line Lk2 are non-parallel to each other. However, in the state in which the second gear 60 is meshed with the first gear 57, the axial center line Lk2 may be parallel to the Y-axis direction, that is, the axial center line Lk1 and the axial center line Lk2 may be parallel to each other.

A section of the second rotation shaft 61 in the −Y direction from the bearing section 73 is pressed in the −X direction by the torsion coil spring 77, that is, is pressed toward the first rotation shaft 58. By this, a force in the −X direction, that is, a force in a direction toward the first gear 57, acts on the second gear 60.

As described above, the bearing section 73, as the second support section that supports the second rotation shaft 61 in the power transmission device 50, has play between itself and the bearing hole 52a, thereby allowing the second rotation shaft 61 to move in the advance and retract direction in which the second gear 60 advances and retracts with respect to the first gear 57, and a force in a direction toward the first gear 57 acts on the second gear 60. By this, a configuration for advancing and retracting the second gear 60 with respect to the first gear 57 can be realized in a space-saving manner, and an increase in the size of the device can be suppressed. That is, compared to a case where a planetary gear mechanism is used, a configuration for advancing and retracting the second gear 60 with respect to the first gear 57 can be realized in a space-saving manner, and an increase in the size of the device can be suppressed. Also, the first gear 57 and the second gear 60 can be appropriately meshed with each other, and appropriate power transmission can be realized.

The power transmission device 50 includes the torsion coil spring 77 as a pressing member that presses the second rotation shaft 61 toward the first rotation shaft 58 and, by the torsion coil spring 77 pressing the second rotation shaft 61, a force in a direction toward the first gear 57 acts on the second gear 60. By this, meshing between the first gear 57 and the second gear 60 can be appropriately maintained.

Note that the pressing by the pressing member may be performed by pulling the second rotation shaft 61 toward the first rotation shaft 58.

Hereinafter, the advance and retract direction of the second gear 60 with respect to the first gear 57, in other words, the direction in which the second gear 60 is pressed against the first gear 57, will be further described.

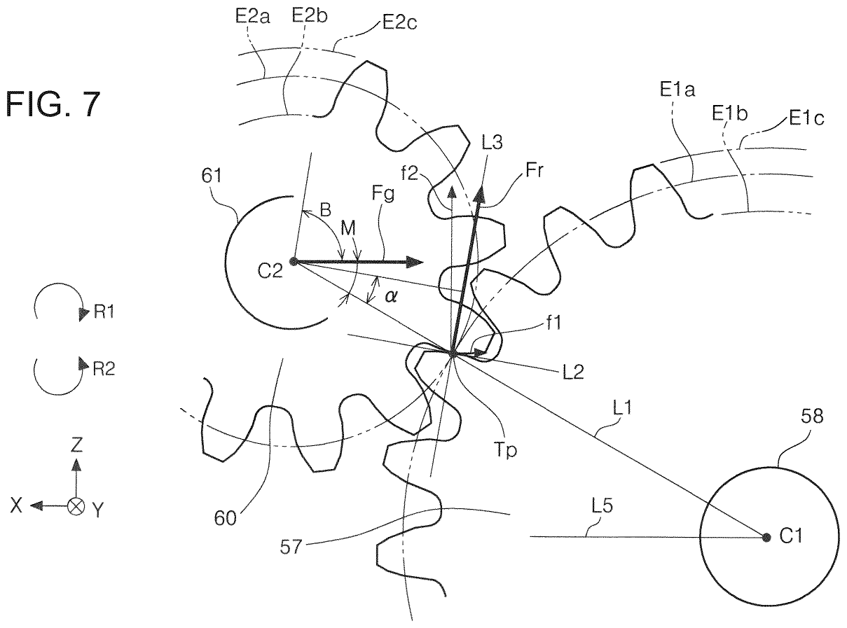

First, a force acting on the meshing section between the second gear 60 and the first gear 57 will be described with reference to FIG. 7.

Here, each reference symbol shown in FIG. 7 will be described. The point C1 is the axial center of the first rotation shaft 58, and is hereinafter referred to as a first axial center C1. The point C2 is the axial center of the second rotation shaft 61, and is hereinafter referred to as a second axial center C2. The straight line L1 is a straight line passing through the first axial center C1 and the second axial center C2.

The point Tp is a pitch point at which a tooth of the first gear 57 and a tooth of the second gear 60 contact each other. The reference symbol L2 is the common tangent of the tooth surfaces at the pitch point Tp, and the reference symbol L3 is the common normal of the tooth surfaces at the pitch point Tp. The reference symbol α is a pressure angle, and a general angle of 20° is adopted, but an angle other than this may be adopted.

The reference symbol E1a is a reference circle of the first gear 57 passing through the pitch point Tp, the reference symbol E1b is the root circle of the first gear 57, and the reference symbol E1c is the tip circle of the first gear 57. The reference symbol E2a denotes a reference circle of the second gear 60 passing through the pitch point Tp, the reference symbol E2b denotes the root circle of the second gear 60, and the reference symbol E2c denotes the tip circle of the second gear 60.

The reference symbol Fg denotes a force that acts on the second gear 60 in the −X direction, that is, in a direction toward the first gear 57. The reference symbol M is an angle formed by the first straight line L1 and the acting direction of the force Fg. The reference symbol B denotes an angle formed by the acting direction of the force Fg and the acting direction of a reactive force Fr (to be described later).

The straight line L5 is a straight line passing through the first axial center C1. The straight line L5 is a straight line parallel to the acting direction of the force Fg, in other words, the advancing direction in which the second gear 60 advances toward the first gear 57.

The second gear 60 rotates in a rotation direction R1 and transmits power to the first gear 57. The first gear 57 receives power from the second gear 60 and rotates in the rotation direction R2. In this case, the second gear 60 receives the reactive force Fr from the first gear 57 at the pitch point Tp. The acting direction of the reactive force Fr is parallel to the common normal line L3. The reference symbol f1 denotes a component force that is a component force of the reactive force Fr and that is parallel to the X-axis direction, that is, to the advance and retract direction of the second gear 60 with respect to the first gear 57. The reference symbol f2 denotes a component force that is a component force of the reactive force Fr and that is a component force in a direction orthogonal to the advance and retract direction.

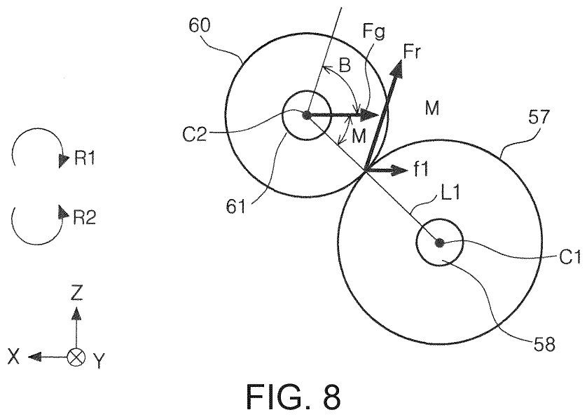

The direction in which the second gear 60 faces the first gear 57 is defined by the angle M. Hereinafter, an embodiment of the direction in which the second gear 60 faces the first gear 57 will be described with reference to FIG. 8 and subsequent drawings. Note that in FIG. 8 and subsequent figures, the gears are simply indicated by representing the reference lines in solid line.

First, the angle M influences the acting direction of the component force f1 and the magnitude of the component force f1. When the acting direction of the component force f1 is opposite to the acting direction of the force Fg and the magnitude of the component force f1 is large, then the force of the second gear 60 toward the first gear 57 becomes small, and there is a possibility that meshing between the second gear 60 and the first gear 57 cannot be appropriately maintained.

When the second rotation shaft 61 is pressed straight toward the first rotation shaft 58, that is, when the angle M is 0°, then the component force f1 becomes larger than when the angle M is larger than 0°. The angle M of 0° means that the first straight line L1 and the acting direction of the force Fg, that is, the advancing direction of the second gear 60, are parallel to each other.

However, as shown in FIG. 7, when the first straight line L1 and the advancing direction of the second gear 60 are non-parallel to each other and also the second axial center C2 is disposed in the direction of the reactive force Fr from the second straight line L5, then the angle M can be made larger than 0°. By this, the component force f1 acts in the advancing direction of the second gear 60, or even if it acts in the opposite direction to the advancing direction of the second gear 60, the magnitude of the component force f1 is reduced. By this, meshing between the first gear 57 and the second gear 60 can be appropriately maintained.

Hereinafter, it will be described in more detail. In FIG. 8, the angle M is set to be larger than the pressure angle α and also smaller than 90°, and the angle B formed by the acting direction of the reactive force Fr and the acting direction of the force Fg is set to be an acute angle.

By this, the component force f1 of the reactive force Fr received by the second gear 60 from the first gear 57 acts in the advancing direction in which the second gear 60 advances toward the first gear 57. By this, meshing between the first gear 57 and the second gear 60 can be appropriately maintained.

In other words, the configuration of FIG. 8 can be said to be a configuration in which, when viewed from the axial direction of the first rotation shaft 58, the first straight line L1 and the advance and retract direction of the second gear 60 are non-parallel to each other and the component force f1 of the reactive force Fr acts in the advancing direction in which the second gear 60 advances toward the first gear 57. By this, meshing between the first gear 57 and the second gear 60 can be appropriately maintained as compared with a case where the component force f1 acts in a direction in which the second gear 60 are retracts from the first gear 57.

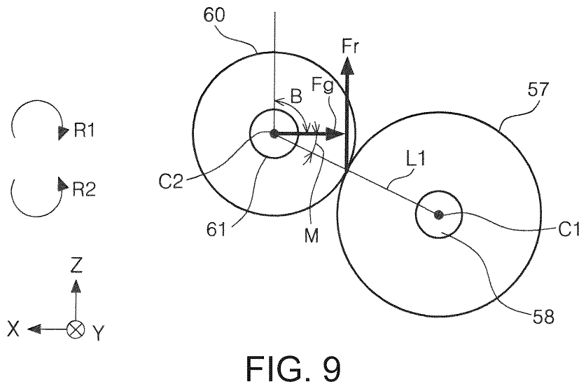

Next, FIG. 9 shows an embodiment in which the angle M is equal to the pressure angle α.

According to such a configuration, the acting direction of the reactive force Fr is orthogonal to the advance and retract direction of the second gear 60. That is, the angle B=90°. This can suppress the reactive force Fr from adversely affecting the force Fg in the direction in which the second gear 60 moves toward the first gear 57.

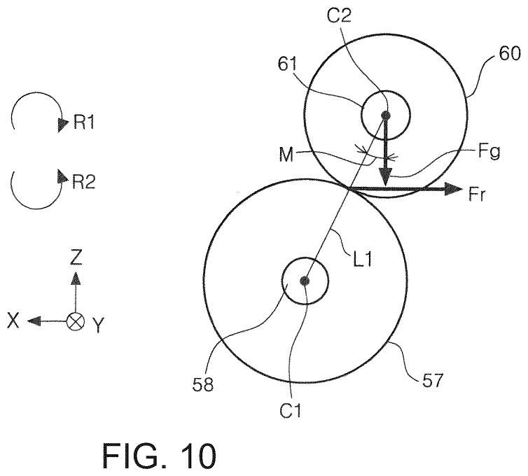

Next, FIG. 10 shows a configuration in which a force Fg in the direction toward the first gear 57 acts on the second gear 60 due to the weight of the second rotation shaft 61 and the weight of the second gear 60.

According to such a configuration, a dedicated component for generating the force Fg, for example, a spring or the like, is not required, or even in a case where a spring is used, the spring force may be small, and thus it is possible to reduce the size and cost of the device.

Note that in FIG. 10, only the weight of the second rotation shaft 61 and the weight of the second gear 60 act on the second gear 60, and no spring force acts on the second gear 60.

Next, other characteristic configurations of the power transmission device 50 according to the present embodiment will be described.

The power transmission device 50 has the housing 70a as a first flanged section coaxial with the first gear 57. Note that the term “coaxial” means that there is a common rotation axis. In the present embodiment, the outer peripheral surface of the housing 70a is a smooth surface without unevenness. The outer peripheral surface of the housing 70a does not protrude radially outward from the tip circle E1c (see FIG. 7) of the first gear 57.

The power transmission device 50 includes a second flanged section 71 coaxial with the second gear 60. In the present embodiment, the outer peripheral surface of the second flanged section 71 is a smooth surface without irregularities. The outer peripheral surface of the second flanged section 71 does not protrude radially outward from the tip circle E2c (see FIG. 7) of the second gear 60.

The sum of the diameter of the housing 70a and the diameter of the second flanged section 71 is smaller than the sum of the diameter of the tip circle E1c (see FIG. 7) of the first gear 57 and diameter of the tip circle E2c (see FIG. 7) of the second gear 60, and is larger than the sum of the diameter of the root circle E1b (see FIG. 7) of the first gear 57 and the diameter of the root circle E2b (see FIG. 7) of the second gear 60.

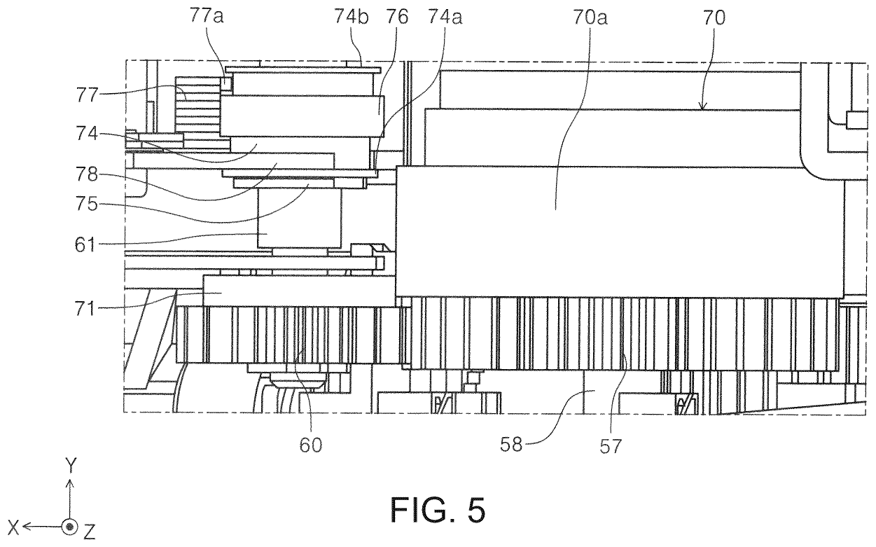

Also, the second flanged section 71 abuts against the housing 70a as illustrated in FIGS. 5 and 6 by the force Fg (see FIG. 7), which acts on the second gear 60 in the direction toward the first gear 57.

By this, the interaxial distance between the first rotation shaft 58 and the second rotation shaft 61 is appropriately maintained, and the first gear 57 and the second gear 60 can appropriately mesh with each other. In particular, even when the force Fg acting on the second gear 60 in the direction toward the first gear 57 is large, the first gear 57 and the second gear 60 can mesh with each other appropriately.

Note that the first flanged section may be provided integrally with the first gear 57, similarly to the second flanged section 71.

In the present embodiment, the housing 70a of the electromagnetic clutch 70 also serves as the first flanged section coaxial with the first gear 57. By this, it is not necessary to provide the first flanged section as a dedicated member, and it is possible to reduce the size and cost of the device.

Note that the electromagnetic clutch 70 may be provided for switching on and off the power transmission between the second rotation shaft 61 and the second gear 60, instead of the configuration in which the electromagnetic clutch 70 is provided for switching on and off the power transmission between the first gear 57 and the first rotation shaft 58.

The first flanged section coaxial with the first gear 57 may be rotatable relative to the first gear 57 and the first rotation shaft 58. Similarly, the second flanged section coaxial with the second gear 60 may be rotatable relative to the second gear 60 and the second rotation shaft 61.

Instead of the configuration in which the interaxial distance between the first gear 57 and the second gear 60 is restricted by abutment of the two flanged sections, a member that abuts against the second rotation shaft 61 may be provided to restrict the second rotation shaft 61 from advancing toward the first rotation shaft 58 and restrict the interaxial distance between the first gear 57 and the second gear 60.

In the present embodiment, as described with reference to FIG. 4, by providing play between the inner peripheral surface of the bearing hole 52a and the outer peripheral surface of the bearing section 73, the second rotation shaft 61 can move so that its axial center line tilts with the bearing section 73 as a fulcrum. However, in place of such a configuration, an alignment bearing may be used for the bearing section 73. By this, a configuration that allows movement of the second rotation shaft 61 can be easily obtained.

Note that in the case where the bearing section 73 is an alignment bearing, there is no need to provide play between the inner peripheral surface of the bearing hole 52a and the outer peripheral surface of the bearing section 73.

Play may be provided between the bearing section 73 and the second rotation shaft 61 so that the second rotation shaft 61 tilts with the bearing section 73 as a fulcrum.

Next, the arrangement of the fourth gear 66 with respect to the third gear 64 will be described with reference to FIG. 11.

In FIG. 11, a straight line L4 is a straight line passing through the second axial center C2 of the second rotation shaft 61 and the third axial center C3 of the third rotation shaft 63. In FIG. 11, the advance and retract direction of the second gear 60 is along the X-axis direction, and the fourth gear 66 moves in the +X direction with movement of the second rotation shaft 61 in the −X direction. The angle Q is an angle formed between the direction in which the fourth gear 66 moves and the straight line L4.

In the present embodiment, the angle Q is 90°, that is, the advance and retract direction of the second gear 60, in other words, the displacement direction of the fourth gear 66, is along a direction orthogonal to the straight line L4.

By this, the following operational effects can be obtained.

When the second rotation shaft 61 moves so that the second gear 60 advances and retracts with respect to the first gear 57, the fourth gear 66 provided on the second rotation shaft 61 is also displaced, and thus there is a concern that meshing between the third gear 64 and the fourth gear 66 may become inappropriate.

However, according to the present embodiment, since the advance and retract direction of the second gear 60, in other words, the displacement direction of the fourth gear 66, is along the direction orthogonal to the straight line L4, even when the second rotation shaft 61 moves, it is possible to suppress change in the interaxial distances between the third rotation shaft 63 and the second rotation shaft 61, and it is possible to suppress that meshing between the third gear 64 and the fourth gear 66 becomes inappropriate.

Note that the advance and retract direction of the second gear 60, in other words, the displacement direction of the fourth gear 66, being along the direction orthogonal to the straight line L4 is not limited to a case where the angle Q is strictly 90°, and means that a certain range is included, and as an example, the angle Q can be appropriately set in a range around 90° by +/−20°.

In the present embodiment, as shown in FIG. 6, the bearing section 73 is located between the second gear 60 and the fourth gear 66 in the axial direction of the second rotation shaft 61. The distance d1 between the fourth gear 66 and the bearing section 73 is shorter than the distance d2 between the second gear 60 and the bearing section 73. By this, when the second rotation shaft 61 moves with the bearing section 73 as a fulcrum, the displacement amount of the fourth gear 66 can be suppressed more than the displacement amount of the second gear 60. By this, improper mesh between the third gear 64 (see FIG. 11) and the fourth gear 66 can be suppressed.

The present disclosure is not limited to the embodiments and modifications described above, various modifications are possible within the scope of the disclosure described in the claims, it is needless to say that they are also included in the scope of the present disclosure.

For example, the angle M may be smaller than the pressure angle x. In this case, the acting direction of the component force f1 of the reactive force Fr is opposite to the acting direction of the force Fg, but the force Fg may be sufficiently larger than the magnitude of the component force f1.

What is claimed is:

1. A power transmission device comprising:
a first gear provided on a first rotation shaft;
a second gear that is provided on a second rotation shaft and that meshes with the first gear;
a first support section that supports the first rotation shaft; and
a second support section that supports the second rotation shaft, wherein
the second support section allows movement of the second rotation shaft in an advance and retract direction in which the second gear advances and retracts with respect to the first gear and
a force in a direction toward the first gear acts on the second gear.

2. The power transmission device according to claim 1, further comprising:
a pressing member that presses the second rotation shaft toward the first rotation shaft, wherein
the force in the direction toward the first gear acts on the second gear by the second rotation shaft being pressed by the pressing member.

3. The power transmission device according to claim 1, wherein
the force in the direction toward the first gear acts on the second gear due to weight of the second rotation shaft and weight of the second gear.

4. The power transmission device according to claim 1, wherein
when viewed from an axial direction of the first rotation shaft, a first straight line that passes through a first axial center of the first rotation shaft and through a second axial center of the second rotation shaft is non-parallel to an advancing direction in which the second gear advances toward the first gear and
assuming that a straight line that passes through the first axial center and that is parallel to the advancing direction is a second straight line, the second axial center is located further than the second straight line in a direction of a reactive force received by the second gear from the first gear.

5. The power transmission device according to claim 4, wherein
when viewed from the axial direction of the first rotation shaft, the first straight line that passes through the first axial center of the first rotation shaft and through the second axial center of the second rotation shaft is non-parallel with the advance and retract direction of the second gear and
a component force of the reactive force received by the second gear from the first gear acts in the advancing direction.

6. The power transmission device according to claim 4, wherein
when viewed from the axial direction of the first rotation shaft, an angle formed by the first straight line that passes through the first axial center of the first rotation shaft and through the second axial center of the second rotation shaft and the advance and retract direction of the second gear is larger than a pressure angle of the second gear and also smaller than 90° and
an angle formed by a direction in which the reactive force received by the second gear from the first gear acts and the advancing direction is an acute angle.

7. The power transmission device according to claim 4, wherein
when viewed from the axial direction of the first rotation shaft, an angle formed by the first straight line that passes through the first axial center of the first rotation shaft and through the second axial center of the second rotation shaft and the advance and retract direction of the second gear is equal to a pressure angle of the second gear.

8. The power transmission device according to claim 1, wherein
the first gear includes a first flanged section coaxial with the first gear,
the second gear includes a second flanged section coaxial with the second gear,
a sum of a diameter of the first flanged section and a diameter of the second flanged section is smaller than a sum of a diameter of a tip circle of the first gear and a diameter of a tip circle of the second gear and also is larger than a sum of a diameter of a root circle of the first gear and a diameter of a root circle of the second gear, and
the second flanged section abuts against the first flanged section by the force acting on the second gear in a direction toward the first gear.

9. The power transmission device according to claim 8, further comprising:
a clutch configured to switch between connection and disconnection of power transmission between the first gear and the first rotation shaft, wherein
a housing of the clutch also serves as the first flanged section.

10. The power transmission device according to claim 1, wherein
the second support section is configured by an alignment bearing.

11. The power transmission device according to claim 1, wherein
the second support section includes a bearing section that receives the second rotation shaft and that is supported by a frame and
the bearing section has play between itself and the frame that allows movement of the second rotation shaft in the advance and retract direction.

12. The power transmission device according to claim 1, further comprising:
a third gear provided on a third rotation shaft and
a fourth gear that is provided on the second rotation shaft spaced apart from the second gear in an axial direction and that meshes with the third gear, wherein
when viewed from an axial direction of the third rotation shaft, the advance and retract direction of the second gear is along a direction orthogonal to a straight line passing through an axial center of the second rotation shaft and an axial center of the third rotation shaft.

13. The power transmission device according to claim 1, further comprising:
a third gear provided on a third rotation shaft and
a fourth gear that is provided on the second rotation shaft spaced apart from the second gear in an axial direction and that meshes with the third gear, wherein
the second support section is located between the second gear and the fourth gear in the axial direction of the second rotation shaft and
a distance between the fourth gear and the second support section is shorter than a distance between the second gear and the second support section.

14. A medium transport device comprising:
the power transmission device according to claim 1 and
a feed roller that feeds a medium by rotating by receiving power from the second gear via the first gear.

15. The medium transport device according to claim 14, further comprising:
a medium support section that supports the medium before feeding, wherein
the feed roller feeds the medium from the medium support section.

16. A recording device comprising:
the medium transport device according to claim 14 and
a recording section that performs recording on the medium transported by the medium transport device.
